(19) United States
(12) Patent Application Publication
(10) Pub. No.: US 2017/0154373 A1
(43) Pub. Date: Jun. 1, 2017

(54) SYSTEM AND METHOD FOR PRICE COMPARISON

(71) Applicants: Inventec (Pudong) Technology Corporation, Shanghai (CN); INVENTEC CORPORATION, Taipei City (TW)

(72) Inventor: Hsu-Tsung HUNG, TAIPEI CITY (TW)

(21) Appl. No.: 15/197,739

(22) Filed: Jun. 29, 2016

(30) Foreign Application Priority Data
Nov. 30, 2015 (CN) 201510854522.2

(51) Int. Cl. G06Q 30/06; G06K 7/14; G06K 19/06

(52) U.S. Cl. CPC G06Q 30/0629; G06K 19/06028; G06K 7/1413

(57) ABSTRACT

The present invention discloses a system and method for price comparison. The method comprises the following steps: recognizing a current position of a mobile device to generate a current position parameter; receiving the current position parameter and a commodity barcode transmitted from the mobile device; looking up a barcode-to-information lookup table with the commodity barcode to determine a selected commodity; looking up a store site parameter table, commodity catalogs with the position parameter, and the selected commodity to determine at least one target store, in which the selected commodity is available, located at a specific distance from the current position; and providing the mobile device with commodity information of the selected commodity in each target store and a cost prediction.

### RELATED APPLICATIONS

This application claims priority to Chinese Application Serial Number 201510854522.2, filed Nov. 30, 2015, which is herein incorporated by reference.

### BACKGROUND

Field of Invention

The present invention relates to a system and method for price comparison.

Description of Related Art

In conventional technology, most price comparison application software or webpages merely provide price comparisons for the same one product and promotional messages of a variety of shops. However, users just receive a comparison result of the webpages passively, and the data of the price comparison application software or webpages are often non-updated. Therefore, users cannot obtain the latest price or special price information promptly.

### SUMMARY

The present invention provides a system and method for price comparison. The system not only let users obtain the price and the special price information of a selected commodity in each store, but also calculates the traffic cost corresponded from the current position of the user to each store. The present invention also calculates the sum of the price of the selected commodity and the corresponded traffic cost, so as to let users choose where to buy the selected commodity according to the total amount of money efficiently. In addition, the system also provide a feedback encouragement mode, which can make users glad to provide the latest price and the special price information of the commodity to a cloud device actively, so as to make the database of the cloud device be maintained in a latest status.

An aspect of the disclosure is to provide a price comparison system, which includes a mobile device and a cloud device. The mobile device having a global positioning system (GPS) that recognizes a current position of the mobile device to generate a current position parameter, and providing a commodity barcode. The cloud device connected to the mobile device through a wireless network, being stored with a store site parameter table, commodity catalogs and a barcode-to-information lookup table of a plurality stores. When the cloud device receives the commodity barcode and the position parameter transmitted from the mobile device, the cloud device determines a selected commodity by looking up the barcode-to-information lookup table with the commodity barcode, and determines at least one target store, in which the selected commodity is available, located at a specific distance from the current position by looking up the store site parameter table and the commodity catalogs with the position parameter and the selected commodity, and then provides the mobile device with a commodity information of the selected commodity in each target store and a cost prediction that comprises the price of the selected commodity in each target store and a transportation expense for moving from the current position to each target store.

In one embodiment of the present invention, the price comparison system further comprises that the cloud device provides users to choose whether to enter a edit mode to edit data through the mobile device when the cloud device determines that the commodity barcode not exists in the barcode-to-information lookup table according to the barcode-to-information lookup table after the cloud device receives and recognizes the commodity barcode transmitted by the mobile device.

In one embodiment of the present invention, the edit mode provides users to input a user account, retailer information, a commodity photo, a commodity name, and a commodity price and/or special price information corresponding to the commodity name.

In one embodiment of the present invention, the cloud device starts a feedback encouragement mode to operate a point feedback according to a data value of a new edit data which is added under the edit made when the cloud device receives the user account through the mobile device and determines that a data editing is complete, and the data value is related to data quantity and a data category.

In one embodiment of the present invention, wherein the cloud device provides users to choose whether to enter an update mode after the cloud device provides commodity information of selected commodity in each target store to the mobile device, the update mode provides users to input a user account and a commodity price and/or a special price information corresponding to the selected commodity, the cloud device starts a feedback encouragement mode to operate a point feedback according to a data value of an update data which is added under the update mode when the cloud device receives the user account through the mobile device and determines that a data updating is complete, and the data value is related to data quantity and a data category.

An aspect of the disclosure is to provide a price comparison method, and the method comprises the following steps: recognizing a current position of a mobile device to generate a current position parameter; receiving the current position parameter and a commodity barcode transmitted from the mobile device; looking up a barcode-to-information lookup table with the commodity barcode to determine a selected commodity; looking up a store site parameter table and commodity catalogs with the position parameter and the selected commodity to determine at least one target store, in which the selected commodity is available, located at a specific distance from the current position; and providing the mobile device with a commodity information of the selected commodity in each target store and a cost prediction that comprises the price of the selected commodity in each target store and a transportation expense for moving from the current position to each target store.

In one embodiment of the present invention, the method further comprises the following step: providing users to choose whether to enter a edit mode to edit data through the mobile device when the cloud device determines that the commodity barcode not exists in the barcode-to-information lookup table according to the barcode-to-information lookup table after receiving and recognizing the commodity barcode transmitted by the mobile device.

In one embodiment of the present invention, wherein the edit mode provides users to input a user account, retailer information, a commodity photo, a commodity name, and a commodity price and/or special price information corresponding to the commodity name.

In one embodiment of the present invention, the method further comprises the following steps: starting a feedback encouragement mode when the cloud device receives the user account through the mobile device and determines that a data editing is complete; and operating a point feedback according to a data value of a new edit data which is added under the edit mode, wherein the data value is related to data quantity and a data category.

In one embodiment of the present invention, the method further comprises the following steps: providing users to choose whether to enter an update mode after providing commodity information of selected commodity in each target stare to the mobile device, wherein the update mode provides users to input a user account and a commodity price and/or a special price information corresponding to the selected commodity; starting a feedback encouragement mode after receiving the user account through the mobile device and determining that a data updating is complete; and operating a point feedback according to a data value of an update data which is added under the update mode, wherein the data value is related to data quantity and a data category.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a block diagram of the price comparison system according to the first embodiment of the present invention;

FIG. 2 is a flowchart of the price comparison method according to the first embodiment of the present invention; and

FIG. 3 is a flowchart of the price comparison method according to the second embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

Due to the limitation of the prior art, the present invention provides a system and method for price comparison, which let users provide the latest price and the special price information of the commodity to a cloud device actively, so as to make the database of the cloud device be maintained in a latest status. In addition, the price comparison system and method of the present invention not only let users obtain the price and the special price information of a selected commodity in each store, but also calculates the traffic cost corresponded from the current position of the user to each store. The present invention also calculates the sum of the price of the selected commodity and the corresponded traffic cost and tells the sum to the users, so as to let users choose where to buy the selected commodity according to the total amount of money efficiently.

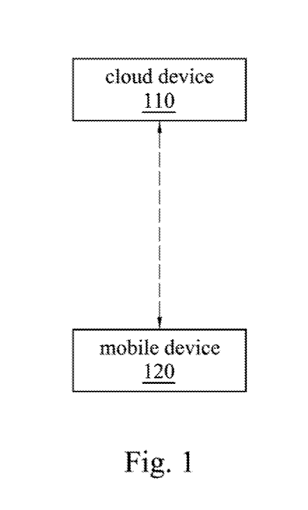

FIG. 1 is a block diagram of the price comparison system according to the first embodiment of the present invention. As illustrated in FIG. 1, the price comparison system of the present invention includes a cloud device 110 and a mobile device 120. The cloud device 110 can be a cloud database provided by an application software corporation. The mobile device 120 can be a cell phone, a tablet, or a Personal Digital Assistant (PDA). The cloud device 110 and the mobile device 120 are connected through wireless network.

A Global Positioning System (GPS) is embedded in the mobile device 120, and the GPS can recognize the current position of the mobile device 120. A store site parameter table corresponding to the GPS of a plurality of stores, commodity catalogs corresponding to each of the plurality stores, and barcode-to-information lookup table corresponding to each of the plurality stores are stored in the cloud device 100.

For the operation of the first embodiment of the present invention, in a store, users see a commodity that they are interested in, and they can use their cell phone to take a picture for the barcode of the commodity they are interested in. Next, the price comparison system uploads the barcode to the cloud database provided by the application software corporation, and the barcode is compared to the data stored in the database, so that the database offers more purchase information to users.

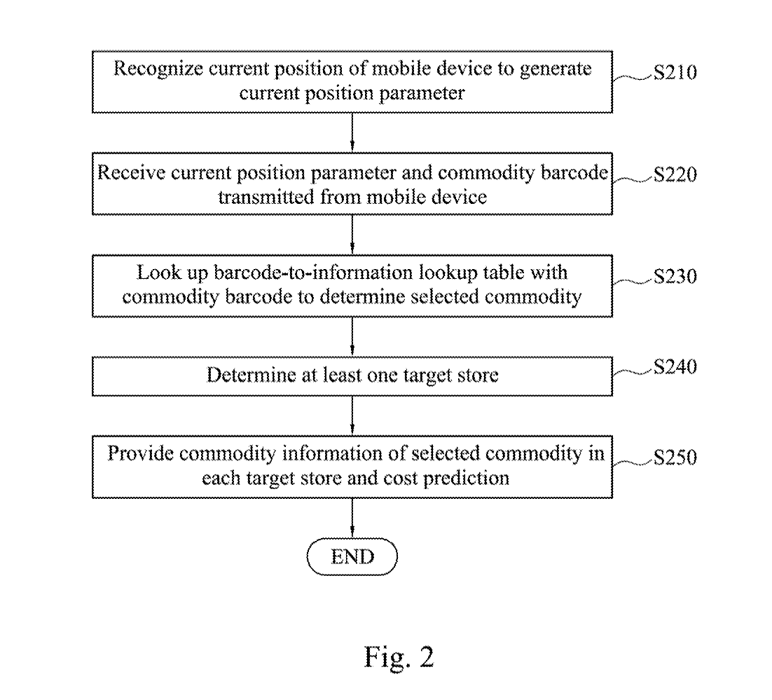

The following description and the drawings explain the operation process of the first embodiment of the present invention. FIG. 2 is a flowchart of the price comparison method according to the first embodiment of the present invention. Referring FIG. 1 and FIG. 2, firstly, the mobile device 120 recognizes a current position of a mobile device to generate a current position parameter (Step 210). Then, the cloud device 110 receives the current position parameter and a commodity barcode transmitted from the mobile device 120 (Step S220). Next, the cloud device 110 looks up a barcode-to-information lookup table with the commodity barcode to determine a selected commodity (Step S230).

Next, the cloud device 110 looks up a store site parameter table, commodity catalogs with the position parameter, and the selected commodity to determine at least one target store, in which the selected commodity is available, located at a specific distance from the current position (Step S240). Then, the cloud device 110 provides the mobile device 120 with commodity information of the selected commodity in each target store and a cost prediction that comprises the price of the selected commodity in each target store and a transportation expense for moving from the current position to each target store (Step S250).

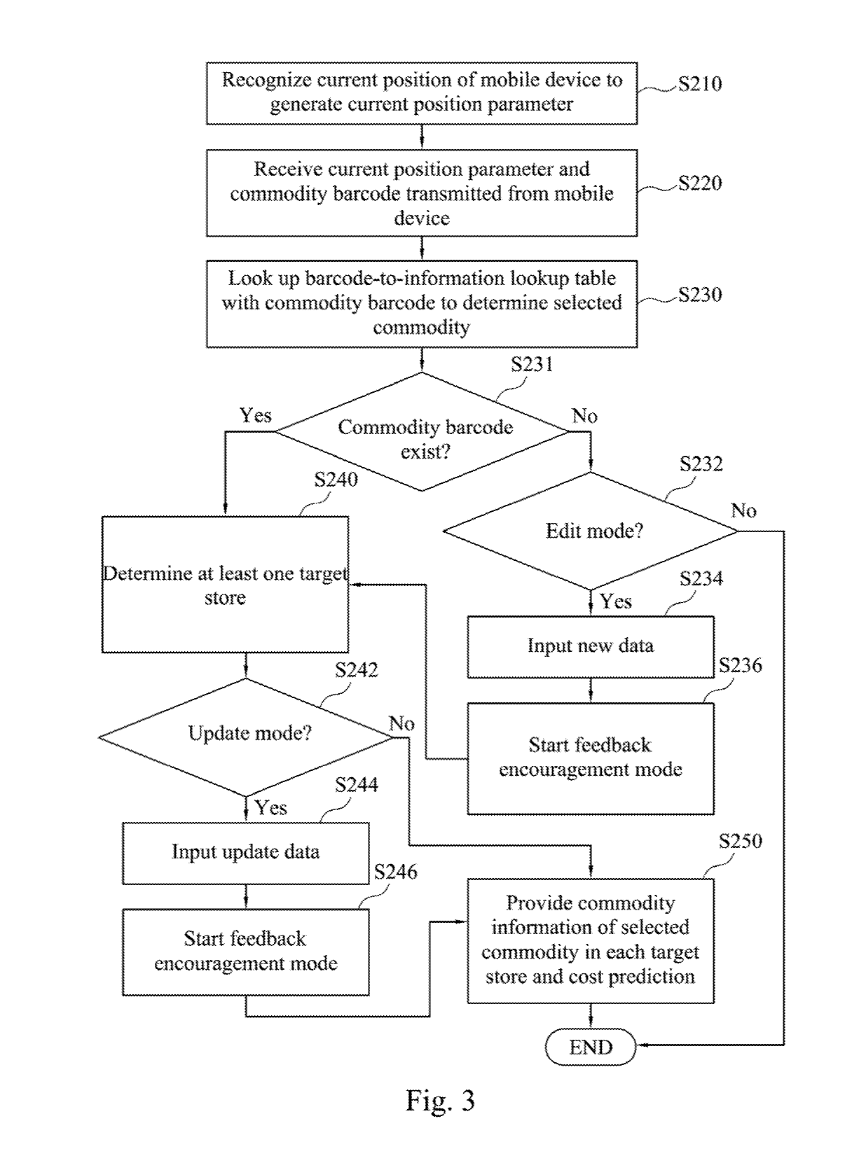

FIG. 3 is a flowchart of the price comparison method according to the second embodiment of the present invention. The difference between embodiment of FIG. 3 and embodiment of FIG. 2 is that: the second embodiment provides a feedback encouragement mode that can make users glad to provide the commodity information to the cloud device 110 actively. Firstly, the mobile device 120 recognizes a current position of a mobile device to generate a current position parameter (Step S210). Then, the cloud device 110 receives the current position parameter and a commodity barcode transmitted from the mobile device 120 (Step S220). Next, the cloud device 110 looks up a barcode-to-information lookup table with the commodity barcode to determine a selected commodity (Step S230).

For the Step S230, after recognizing the commodity barcode to find the selected commodity according to the barcode-to-information lookup table, the cloud device 110 determines whether the commodity barcode exists in the barcode-to-information lookup table or not (Step S231). If the determination of the Step S231 is Yes, the cloud device 110 looks up a store site parameter table, commodity catalogs with the position parameter, and the selected commodity to determine at least one target store, in which the selected commodity is available, located at a specific distance from the current position (Step S240). Users can set the specific distance. For example, users want to know which store locates near them within 200 meters and sells the selected commodity, the specific distance can be set as 200 meters.

If the determination of the Step S231 is No, the cloud device 110 inquires users whether entering an edit mode through the mobile device 120 (Step S232). If the determination of the Step S232 is No, the price comparison method is ended. If the determination of the Step S232 is Yes, enters the edit mode to provide users to input data (Step S234). The edit mode provides users to input a user account, retailer information, a commodity photo, a commodity name, and a commodity price and/or special price information corresponding to the commodity name.

Next, the cloud device 110 starts a feedback encouragement mode when the cloud device 110 receives the user account through the mobile device 120 and determines that a data editing is complete. The cloud device 110 operates the point feedback according to a data value of a new edit data that is added under the edit mode (Step S236) The data value is related to data quantity and a data category. For example, the quantity of data is more, and the feedback points will be more. If the category of the data is “new edit data”, the feedback points of the “new edit data” will be more than “update data.” In addition, the data value is also related to the reliability of the data. The reliability of the data is higher, and the feedback points will be more. The cloud device 110 has a point-feedback table. Based on the point-feedback table, the cloud device 110 recognizes the feedback points according to the value of the new edit data or the update data. Then, the cloud device 110 adds the feedback points to the user's account and returns the feedback information to the mobile device 120, so as to let the user know how many the feedback points can obtain corresponding to the editing or updating data through the mobile device 120. After that, the cloud device 110 looks up a store site parameter table, commodity catalogs with the position parameter, and the selected commodity to determine at least one target store, in which the selected commodity is available, located at a specific distance from the current position (Step S240).

Next, the cloud device 110 inquires the user whether entering an update mode through the mobile device 120 (Step S242). If the determination of the Step S242 is No, the cloud device 110 provides the mobile device 120 with commodity information of the selected commodity in each target store and a cost prediction that comprises the price of the selected commodity in each target store and a transportation expense for moving from the current position to each target store (Step S250). Namely, users can know the sum of the selected commodity's price in each of the stores and a corresponded transportation expense easily. Accordingly, users can make a choice of where to buy.

If the determination of the Step S242 is Yes, enter to an update mode to provide users to input update data (Step S244). The update mode provides users to input a user account and a commodity price and/or special price information corresponding to the selected commodity. The cloud device 110 starts the feedback encouragement mode after receiving the user account through the mobile device 120 and determining that a data updating is complete. The cloud device 110 operates the point feedback according to a data value of an update data that is added under the update mode (Step S246). The data value is related to data quantity and the data category.

After the Step S246, the cloud device 110 provides the mobile device 120 with commodity information of the selected commodity in each target store and a cost prediction that comprises the price of the selected commodity in each target store and a transportation expense for moving from the current position to each target store (Step S250). In the second embodiment, users not only can obtain the greater price comparison result by adding the traffic cost, but also get the feedback points through editing or updating data according to the feedback encouragement mode. Accordingly, the commodity information of the cloud device 110 can be maintained in the latest status.

The present invention provides a system and method for price comparison. The system not only let users obtain the price and the special price information of a selected commodity in each store, but also calculates the transportation expense corresponded from the current position of the user to each target store. The present invention also calculates the sum of the price of the selected commodity and the corresponded transportation expense, so as to let users choose where to buy the selected commodity according to the total amount of money efficiently. In addition, the system also provide a feedback encouragement mode, which can make users glad to provide the latest price and the special price information of the commodity to a cloud device actively, so as to make the database of the cloud device be maintained in a latest status.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A price comparison system, comprising:
a mobile device, having a global positioning system (GPS) that recognizes a current position of the mobile device to generate a current position parameter, and providing a commodity barcode; and
a cloud device connected to the mobile device through a wireless network, being stored with a store site parameter table, commodity catalogs and a barcode-to-information lookup table of a plurality stores,
wherein when the cloud device receives the commodity barcode and the position parameter transmitted from the mobile device, the cloud device determines a selected commodity by looking up the barcode-to-information lookup table with the commodity barcode, and determines at least one target store, in which the selected commodity is available, located at a specific distance from the current position by looking up the store site parameter table and the commodity catalogs with the position parameter and the selected commodity, and
then provides the mobile device with a commodity information of the selected commodity in each target store and a cost prediction that comprises the price of the selected commodity in each target store and a transportation expense for moving from the current position to each target store.

2. The price comparison system of claim 1, wherein the cloud device provides users to choose whether to enter a edit mode to edit data through the mobile device when the cloud device determines that the commodity barcode not exists in the barcode-to-information lookup table according to the barcode-to-information lookup table after the cloud device receives and recognizes the commodity barcode transmitted by the mobile device.

3. The price comparison system of claim 2, wherein the edit mode provides users to input a user account, a retailer information, a commodity photo, a commodity name, and a commodity price and/or a special price information corresponding to the commodity name.

4. The price comparison system of claim 3, wherein the cloud device starts a feedback encouragement mode to operate a point feedback according to a data value of a new edit data which is added under the edit mode when the cloud device receives the user account through the mobile device and determines that a data editing is complete, and the data value is related to data quantity and a data category.

5. The price comparison system of claim 1, wherein the cloud device provides users to choose whether to enter an update mode after the cloud device provides commodity information of selected commodity in each target store to the mobile device, the update mode provides users to input a user account and a commodity price and/or a special price information corresponding to the selected commodity, the cloud device starts a feedback encouragement mode to operate a point feedback according to a data value of an update data which is added under the update mode when the cloud device receives the user account through the mobile device and determines that a data updating is complete, and the data value is related to data quantity and a data category.

6. A price comparison method, comprising:
recognizing a current position of a mobile device to generate a current position parameter;
receiving the current position parameter and a commodity barcode transmitted from the mobile device;
looking up a barcode-to-information lookup table with the commodity barcode to determine a selected commodity;
looking up a store site parameter table and commodity catalogs with the position parameter and the selected commodity to determine at least one target store, in which the selected commodity is available, located at a specific distance from the current position; and
providing the mobile device with a commodity information of the selected commodity in each target store and a cost prediction that comprises the price of the selected commodity in each target store and a transportation expense for moving from the current position to each target store.

7. The price comparison method of claim 6, further comprising:
providing users to choose whether to enter a edit mode to edit data through the mobile device when the cloud device determines that the commodity barcode not exists in the barcode-to-information lookup table according to the barcode-to-information lookup table after receiving and recognizing the commodity barcode transmitted by the mobile device.

8. The price comparison method of claim 7, wherein the edit mode provides users to input a user account, a retailer information, a commodity photo, a commodity name, and a commodity price and/or a special price information corresponding to the commodity name.

9. The price comparison method of claim 8, further comprising:
starting a feedback encouragement mode when the cloud device receives the user account through the mobile device and determines that a data editing is complete; and
operating a point feedback according to a data value of a new edit data which is added under the edit mode, wherein the data value is related to data quantity and a data category.

10. The price comparison method of claim 6, further comprising:
providing users to choose whether to enter an update mode after providing commodity information of selected commodity in each target store to the mobile device, wherein the update mode provides users to input a user account and a commodity price and/or a special price information corresponding to the selected commodity;
starting a feedback encouragement mode after receiving the user account through the mobile device and determining that a data updating is complete; and
operating a point feedback according to a data value of an update data which is added under the update mode, wherein the data value is related to data quantity and a data category.
